(19) United States
(12) Patent Application Publication
(10) Pub. No.: US 2013/0341093 A1
(43) Pub. Date: Dec. 26, 2013

(54) DRILLING RISK AVOIDANCE

(71) Applicants: Stuart Inglis Jardine, Houston, TX (US); Maurice Ringer, Cambridge (GB)

(72) Inventors: Stuart Inglis Jardine, Houston, TX (US); Maurice Ringer, Cambridge (GB)

(21) Appl. No.: 13/529,622

(22) Filed: Jun. 21, 2012

(51) Int. Cl. G06F 17/18; E21B 7/00; G06F 17/10; E21B 47/00

(52) U.S. Cl. 175/40; 175/57; 703/2; 702/6

(57) ABSTRACT

A method can include proposing a new well; accessing data associated with at least one other well where at least a portion of the data includes indicia of uncertainty; performing a geostatistical analysis of the accessed data for an issue for drilling of the new well to provide a probability of occurrence for the issue and an uncertainty for the accessed data; and rendering to a display a graphical representation of the well, the probability of occurrence for the issue and the uncertainty for the accessed data as a function of depth. Various other apparatuses, systems, methods, etc., are also disclosed.

### BACKGROUND

Drilling of a wellbore is accomplished through use of a machine referred to as a rig or drilling package. A rig can include components such as mud tanks, mud pumps, a derrick or mast, drawworks, a rotary table or topdrive, a drillstring, power generation equipment and auxiliary equipment. Drilling forms a hole known as a wellbore, where the term “borehole” may refer to the inside diameter of the wellbore wall (e.g., the rock face that bounds the drilled hole).

As to “mud”, it is a term used for drilling fluids that contain suspended solids. The term “mud weight” refers to mass per unit volume of a drilling fluid also known as “mud density”. Mud weight can control hydrostatic pressure in a wellbore and, for example, help to prevent unwanted flow of fluid(s) into the wellbore. The weight of mud can also help to prevent collapse of casing, an openhole, etc. Excessive mud weight can cause lost circulation by propagating, and then filling, fractures in rock.

As to a “drillstring”, as an example, it can include drillpipe, bottomhole assembly and possibly other tools used to make a drill bit turn at the bottom of a wellbore. A drill bit is the tool used to crush or cut rock. Various components of a rig can directly or indirectly assist the bit in crushing or cutting rock. The bit is located at the bottom of a drillstring and, for example, if it becomes excessively dull, one option may be to remove the drillstring from the wellbore for replacement of the bit. Most bits work by scraping or crushing rock, or both (e.g., via rotational motion). Some bits, known as hammer bits, pound the rock akin to a construction site air hammer.

A wellbore may be drilled according to a plan. A plan may include a route that deviates from vertical or a straight line. To achieve directional drilling, a drillstring can include a bend near a bit in a downhole steerable mud motor. Such a bend can point the bit in a direction different from an axis of the drilled portion of the wellbore, for example, when the entire drillstring is not rotating. By pumping mud through the mud motor, the bit turns while the drillstring does not rotate, allowing the bit to drill in the direction it points. When a particular wellbore direction is achieved, that direction may be maintained by rotating the entire drillstring (including the bent section). Rotary steerable tools allow steering while rotating, for example, with higher rates of penetration that may produce smoother boreholes.

Various events can occur during drilling of a wellbore that may impact cost, timings, future production, etc. Various technologies and techniques described herein are, for example, directed to planning, drilling or planning and drilling.

### SUMMARY

A method can include proposing a new well, accessing data associated with at least one other well, performing a statistical analysis of the accessed data for an issue for drilling of the new well to provide a probability of occurrence for the issue and an uncertainty as a function of depth. A system can include one or more processors, memory, an interface to receive information for a proposed new well and to receive data associated with at least one other well, instructions stored in a portion of the memory and executable by at least one of the one or more processors to perform a statistical analysis of the received data for an issue for drilling of the new well to provide a probability of occurrence for the issue and an uncertainty as a function of depth. One or more computer-readable storage media can include instructions to access data associated with at least one well, perform a statistical analysis of the accessed data for an issue for drilling of a new well to provide a probability of occurrence for the issue and an uncertainty as a function of depth. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system and examples of graphical user interfaces;

FIG. 3 illustrates an example of a graphical user interface and examples of statistical analysis modules;

FIG. 4 shows an example of a method;

FIG. 5 illustrates an example of a graphical user interface that include various information as to event probability and data uncertainty;

FIG. 6 illustrates an example of a system configured to receive input via one or more graphical user interfaces;

FIG. 7 illustrates an example of a system that includes a station and a mobile station;

FIG. 8 illustrates an example of a method;

FIG. 9 illustrates an example of a method;

FIG. 10 illustrates an example of a method;

FIG. 11 illustrates an example of a method; and

FIG. 12 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Various examples of technologies and techniques are described herein, for example, for identifying hazards, reducing risks and improving early detection of problems during wellbore drilling operations. As an example, recorded information from nearby wells (e.g., drilled within a relevant neighboring area), can be analyzed with respect to one or more types of issues (e.g., events). During an actual drilling process, additional data may be acquired and analyzed separately or in conjunction with the nearby well data. As an example, an analysis may provide for semi-automated or automated detection capabilities for a new well that is planned to be drilled or actually being drilled. Such capabilities may provide for early detection and avoidance of drilling problems (e.g., fluid influxes (kicks), fluid losses, drill-pipe or borehole washouts, sticking pipe, lost circulation, low rate-of-penetration (ROP), abrasive sands, etc.). As an example, an analysis may integrate with sensing, control and automation of a drilling process. As an example, a sensor, control algorithm, etc., may be adjusted (e.g., sensitivity, alarm limit, etc.) based at least in part on an analysis of data from one or more offset wells, optionally as a function of depth during drilling of a new well.

As an example, a drilling information system can include three components. In such an example, a first component can provide access to one or more databases that store offset well data as well as access to a framework for modeling a geologic environment; a second component can provide for monitoring measurements and associating such measurements with one or more types of events (e.g., fluid influxes (kicks), fluid losses, drill-pipe or borehole washouts, sticking pipe, lost circulation, low ROP, abrasive sands, etc.); and a third component can provide for real time control and automation, for example, for avoidance of one or more types of events (e.g., based on the first and second components). As an example, the second component may be applied to real time or stored data for offset wells and leveraged for purposes of drilling of a new well. Further, as an example, the third component may provide for real time monitoring to supplement offset well data for purposes of avoiding one or more types of events. The foregoing system can involve one or more statistical analyses to provide information germane to decision making, which may be manual, semi-automated or automated.

As an example, provided with relevant data, a system may automatically analyze the data to identify one or more problem zones. In such an example, the relevant data may include indicia of uncertainty (e.g., an associated metric or metrics that are indicators of uncertainty). For example, where the data stems from a wellbore that is a certain distance offset from a proposed new well, that data may be less certain than data that stems from a wellbore closer in proximity to the proposed new well. Thus, as an example, indicia of uncertainty may be based on distance of an offset well from a proposed new well (e.g., a metric based at least in part on the distance). As another example, a fault may actually exist or be thought to exist between a proposed new well and an offset well. Given the actual existence or perceived existence (e.g., based on some uncertain data, which may be quantitative, qualitative or quantitative and qualitative), data associated with the offset well may be deemed as having some degree of uncertainty. For example, stratigraphic layers may be offset in depth bordering a fault. Thus, the uncertainty for the offset well may be with respect to its depth location (e.g., depth X+/−Y % where the value Y may be indicia of uncertainty). Accordingly, the data from an offset well may be accurate yet have some degree of uncertainty with respect to how it would apply to a new well. Such uncertainty may optionally be determined and assigned to the data through use of a model of a geologic environment that can include representations of the offset well and the new well. Uncertainty may arise from any of a variety of factors, for example, manner of accessing data, manner of searching for data, age of data, equipment used to acquire data, amount of data acquired, degree of correlation to other data, training of person that acquired the data, training of person that interpreted data, etc.

As an example, a system may analyze data for purposes of reducing false alarms and improving identification of problems at an early stage in a drilling process. Such a system may perform an analysis by combining offset well history data with real time monitoring and warning data from a well being drilled.

As to data acquired during a drilling process, these data may be acquired via measurement-while-drilling (MWD) equipment and include data pertaining to, for example, tool orientation, downhole flow-rate measurements, gamma-ray measurements, etc. As an example, data associated with an offset well or a new well may be acquired in the presence of an event or a false alarm, which, in turn, allows for associating data with an event or condition(s) that gave rise to a false alarm. As to a false alarm, associated data may be analyzed to determine whether one or more degrees of uncertainty should be assigned to the data. For example, if the data were insufficient in amount (e.g., according to one or more criteria), then a degree of uncertainty with respect to the issue may be assigned when data are likewise deemed insufficient in amount. As another example, if data are noisy due to some type of operational interference or if data are otherwise deemed noisy (e.g., via an analysis for noise or given knowledge of operational conditions when acquired), then that data may be assigned a degree of uncertainty (e.g., using one or more statistical techniques).

As to an example of a technique for analysis of data, the technique described in U.S. Pat. No. 5,952,569, which is incorporated herein by reference, may be implemented. The technique described in U.S. Pat. No. 5,952,569 uses the theorem of Bayes for a model M and data D acquired during real time drilling of a well to determine a probability value of an event occurring during the real time drilling of that well where the posterior probability Pr(M|D) is [Pr(D|M) Pr(M)]/Pr(D). The technique described in U.S. Pat. No. 5,952,569 also includes a probabilistic comparator that compares vectors of data to representations of possible vectors of data which in turn can be assigned to alarms. Specifically, a vector Pr containing normalized posterior probabilities is generated based on Pr(M), which is a vector of the normalized prior probabilities of the model data, and a scaled logarithmic likelihood vector Iₛ. However, as noted in U.S. Pat. No. 5,952,569, when the data contain a lot of noise, the track (event probability) could reach 100% and then fall back rapidly, or it could hover around 50%, which can leave assessments of such fluctuations in probability to a user.

In various examples, an analysis process may include use of Bayes theorem. For example, where data from multiple sources exist, the following equation (Equation 1) may be used:

$$p ( {x}_{r} \vert {d}_{rt} , {d}_{o} ) = \frac{p ( {d}_{rt} \vert {x}_{r} ) p ( {x}_{r} \vert {d}_{o} )}{p ( {d}_{rt} )}$$

where xᵣ is a physical property, dᵣₜ is a real time measurement from a new well and dₒ is information from another source or sources (e.g., offset wells). In Equation 1 p(dᵣₜ|xᵣ) is the likelihood of measuring dᵣₜ given the property xᵣ and p(xᵣ|dₒ) is the likelihood log derived from the data from the one or more other sources (e.g., offset wells).

With respect to an alarm, for example, the following equation (Equation 2) may be used:

$$p ( a \vert {x}_{rt} , {x}_{e} ) = \frac{p ( {x}_{rt} \vert a ) p ( a \vert {x}_{e} )}{p ( {x}_{rt} )}$$

where xₑ is the likelihood of an event, and xᵣₜ represents features extracted from the real time data that are intended to indicate whether a problem is occurring and, for example, is based on the instantaneous measurements.

As an example, a system can provide two levels of control: one that monitors the probability of a problem event occurring, xₑ, and suggests control parameters based on this information, and one that reacts to alarms generated when the problem event occurs.

As mentioned, data may be uncertain for one or more reasons. As an example, where data are uncertain, an indicator may be provided with a probability of an event occurring based on that data. In such a manner, the probability value (or graphic) can be readily assessed. As an example of an alternative arrangement, a probability value (or graphic) may not be generated, stored or rendered where uncertainty of underlying data is deemed highly uncertain (e.g., according to a limit or limits).

As an example, uncertain data may be classified. As to classification of uncertain data (e.g., to assign a degree of uncertainty), one or more types of approaches may be taken. For example, an approach may rely on an analysis of data sufficiency, data noise, or, as mentioned, one or more physical factors (e.g., based on a model of geologic environment). As an example, a Bayesian classifier may be implemented to classify uncertain data. An example of a Bayesian classifier for uncertain data is described in an article by Qin et al. Bayesian Classifier for Uncertain Data” (SAC '10, Proceedings of the 2010 ACM Symposium on Applied Computing), which is incorporated by reference herein. In the article by Qin et al., error for a variable Z can be represented as a left error and a right error, which may be approximated by a left Gaussian distribution and a right Gaussian distribution, across an interval (e.g., A to B). The approach in the article by Qin et al. can also apply to “certain” data (e.g., A=B=Z); noting that a traditional Bayesian classifier works with the center points of uncertain intervals and computes the data distribution parameters based on the center points while the aforementioned uncertain Bayesian classifier considers centers, left and right boundaries and interval length. Such an approach can include training using training data and updating as more data becomes available.

As an example, for data from multiple offset wells, statistical analysis of the data (e.g., with respect to depth) may be performed to assign individual or overall uncertainty to the data. For example, a correlation process may correlate well log data (e.g., optionally using a model of a geologic environment) and then assign an uncertainty to the well log data from each well based on a correlation value (e.g., from −1 to +1 where +1 would be most certain). In such an example, the model may be history matched and considered to provide a “best” data profile such that a correlation value of +1 would be correlated with the “best” data profile.

As an example, offset well information may be combined with real time estimates of a problem event or problem events in a well being drilled. In such an example, data from offset wells and the well being drilled may be processed with respect to each type of event (e.g., fluid influx or “kick” during a drilling operation) that may occur during drilling (e.g., according to defaults or selections made from a list of types of events). Various types of data (e.g., recorded and stored signals) from the offset wells may be compared to a number of possible data (e.g., or signals) to compute a probability value of occurrence for an event as a function of depth (e.g., optionally multidimensional position) in each of the offset wells or collectively for a number of the offset wells. For example, the probability values of occurrence for the event in the offset wells can be combined to generate an overall probability of occurrence log. As an example, whether a collection of individual logs or an overall log, the log(s) may be stored and analyzed in the context of a model of a geologic environment, for example, to identify one or more events that correlate with subsurface properties. In the model, such properties may have already been derived from seismic, other previously recorded measurements, etc., to enable identification of subsurface structures and lithology information. As an example, given an event-related analysis of data from offset wells in an area that has been drilled (e.g., defined as having similar lithology sequences), a method can provide a reference model for one or more proposed new wells that includes probabilities of occurrence of an event or events over the path or paths of the one or more proposed new wells.

As an example, uncertainty as to the data underlying a probability of occurrence log for an event or for events may be determined. Uncertainty may be determined in one or more manners. As mentioned, uncertainty may be determined based on location of an offset well with respect to a proposed new well, based on quality of the data from an offset well or wells, etc. As another example, uncertainty may be based on the number of offset wells used to determine a probability of occurrence log for an event or events. In such an example, if relatively few offset wells are used as data sources, then this information can be stored with the probability of occurrence log for the event or events.

In addition to event probabilities of occurrence, other information can be gained from analysis of data from offset wells. For example, information such as estimates of pore and fracture pressure, models of rock hardness, susceptibility to swelling and estimates of parameters of models such as the bit-rock interaction may be gained from an analysis of data from one or more offset wells. Such data may form logs that differ from an event probability of occurrence log in that they provide estimates of physical properties. As an example, physical property logs and event-related logs from one or more offset wells may be combined to provide an event probability of occurrence log for a proposed new well. Further, such logs may be combined with real time data acquired during drilling of the new well (e.g., drilling fluid properties, bit type, etc.).

As an example, during planning, a method may include separating the probability of occurrence of an event from drilling parameters used in an offset well to create a new probability of occurrence of the event for use in drilling a new well (e.g., using appropriate drilling parameters, which may differ from those of the offset well). As another example, data from multiple offset wells may be accessed and analyzed in bulk, optionally with filtering as to depth, type or types of events experienced, etc. (e.g., using quantitative, qualitative or quantitative and qualitative filters). In either of the foregoing examples, results from analysis of the data are provided with respect to a new well, which may be a proposed new well (e.g., drilling has not yet commenced) or a new well that is being drilled. Techniques for providing results for a new well may include spatial interpolation, optionally using lithology, for example, as provided in a model of a geologic environment. Interpolation may include application of statistical techniques such as kriging. Kriging refers to various types of statistical techniques for interpolation to provide a value of a parameter at an “unobserved” location (e.g., spatial, spatial and time, etc.) from observations of values for that parameter at other locations (e.g., nearby locations). As an example, a system may provide for interpolation of data, probabilities, uncertainties or combinations thereof. In such a manner, information associated with one or more offset wells may be analyzed for purposes of planning, drilling or planning and drilling a new well.

As to drilling of a new well, a graphical user interface may be presented on a display (e.g., by execution of code, rendering, etc.) that provides information as to probability of occurrence for one or more types of events along with uncertainty of data underlying the probability or probabilities of occurrence. As an example, uncertainty of data may play an indirect role where a high uncertainty (e.g., according to one or more criteria) for a portion of a planned wellbore path causes the graphical user interface to not render a probability of occurrence over that portion of the planned well path as, due to the high uncertainty, the probability may be unreliable.

As an example, a graphical user interface may be presented as a traffic light for a drilling process corresponding to bit position (e.g., for a portion of rock slightly ahead of bit position) where, for example, a green light indicates low probability of occurrence with an acceptable level of uncertainty, a yellow light indicates a medium probability of occurrence with an acceptable level of uncertainty and red light indicates a high probability of occurrence with an acceptable level of uncertainty. In such an example, where uncertainty is unacceptable, the traffic light may render no colored lights, or optionally a different color light (e.g., blue) to indicate that due to uncertain data no probability of occurrence is being shown. In such an instance, drilling operators may resort to other information to continue the drilling process. A graphical user interface (e.g., “GUI”) may be rendered to a display, projected, etc., in various manners (e.g., via graphics processing instructions, via images, etc.) and may be interactive using commands received by input using a touchscreen, a pointing device, voice, mechanical motion, light, etc.

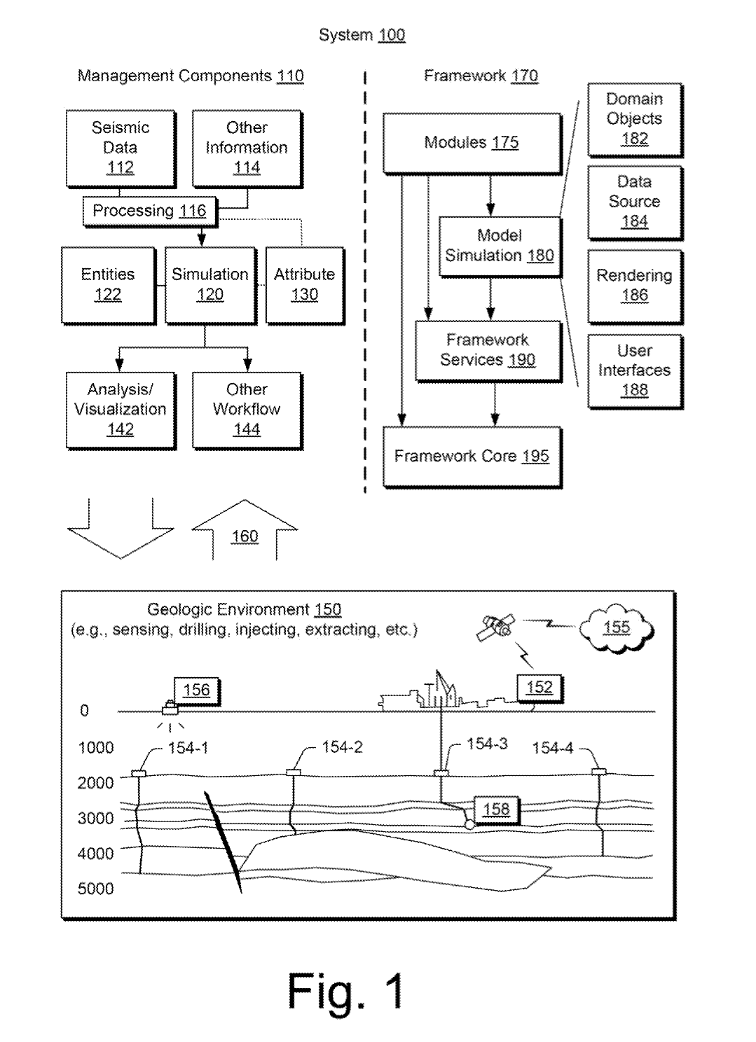

Various examples of techniques, technologies, etc., are described below, where FIG. 1 shows a system 100 with respect to a geologic environment that includes a new well and some offset wells. While FIG. 1 shows a subsea environment, techniques, technologies, etc., described herein may be applied to other environments. Further, while various examples pertain to wells associated with hydrocarbons, techniques, technologies, etc., described herein may be applied to other types of wells (e.g., water, carbon dioxide, etc.).

FIG. 1 shows an example of a system 100 that includes various management components 110 to manage various aspects of a geologic environment 150 (e.g., an environment that includes a sedimentary basin). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114).

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT®.NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120. Alternatively, or in addition, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

In an example embodiment, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components (e.g., or modules) may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids (e.g., defined by nodes).

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components (e.g., for GUI generation, rendering and interaction).

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project and, at a later time, the project may be accessed (e.g., by the same user, another user, an executing program, etc.) and restored using the model simulation layer 180, which can recreate instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 158, which may be equipment to drill, acquire information, assist with resource recovery, etc. Other equipment 156 may be located remote from a well site and include processing, sensing, detecting, emitting or other circuitry. Such equipment may include storage and communication circuitry to store and to communicate data, instructions, etc. The geologic environment 150 also shows various wells (e.g., wellbores) 154-1, 154-2, 154-3 and 154-4. In the example of FIG. 1, the downhole equipment 155 may include a drill for drilling the well 154-3. In such an example, the wells 154-1, 154-2 and 154-3 may be referred to as offset wells.

The framework 170 may provide for modeling the geologic environment 150 including the wells 154-1, 154-2, 154-3 and 154-4 as well as stratigraphic layers, lithologies, faults, etc. The framework 170 may create a model with one or more grids, for example, defined by nodes, where a numerical technique can be applied to relevant equations discretized according to at least one of the one or more grids. As an example, the framework 170 may provide for performing a simulation of phenomena associated with the geologic environment 150 using at least a portion of a grid. As to performing a simulation, such a simulation may include interpolating geological rock types, interpolating petrophysical properties, simulating fluid flow, or other calculating (e.g., or a combination of any of the foregoing).

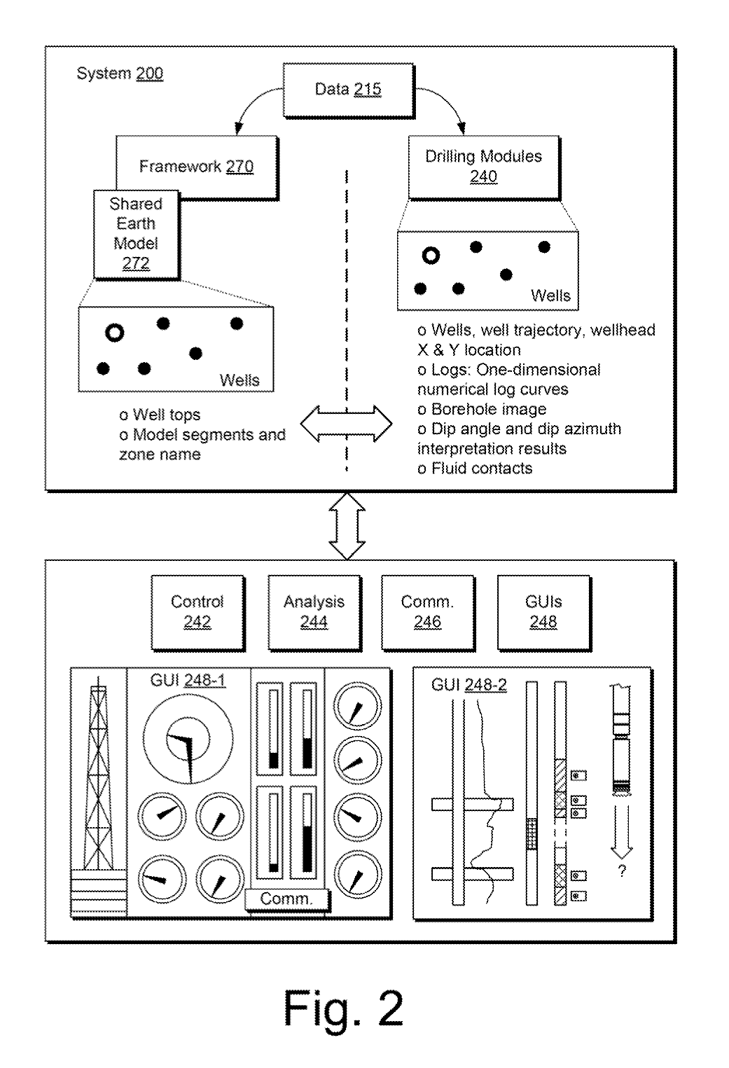

FIG. 2 shows an example of a system 200 that includes data 215, drilling modules 240 and a framework 270, which may be a framework such as the framework 170 of FIG. 1. As to the drilling modules 240, these may include a control module 242, an analysis module 244, a communication module 246 and one or more graphical user interface (GUI) modules 248, for example, to organize data and graphics commands for rendering of a GUI 248-1, a GUI 248-2, etc. In the example of FIG. 2, the GUIs 248-1 and 248-2 provide information relevant to a drilling process where such information may include real time information.

As an example, the drilling modules 240 may include one or more modules of the commercially available TECHLOG® wellbore framework (Schlumberger, Houston, Tex.) which provides wellbore-centric, cross-domain workflows based on a data management layer. The TECHLOG® wellbore framework includes features for petrophysics (core and log), geology, drilling, reservoir and production engineering, and geophysics.

As indicated in FIG. 2, information may be exchanged between the framework 270 and the drilling modules 240, optionally using plug-ins, APIs, etc. Such transfers may allow for spatial mapping, temporal mapping or spatial and temporal mapping of data between the framework 270 and the drilling modules 240. As an example, the framework 270 may access information associated with the drilling modules 240 pertaining to wells, well trajectory, wellhead location, logs, borehole images, dip angle and dip azimuth interpretation results, fluid contacts, etc. As an example, the drilling modules may access information associated with the framework 270 pertaining to well tops, model segments and zone name (e.g., for a model that includes one or more grids).

As to the data 215, it may be stored in one or more data storage devices locally, remotely, or locally and remotely. Such data may include seismic data, interpreted data, model data, measurement data, qualitative data, etc. Portions of such data may be relevant to the drilling modules 240 directly and/or the framework 270 directly. As shown in the example of FIG. 2, information transfers between the drilling modules 240 and the framework 270 may include other data, for example, acquired from one or more other sources and may include analyzed data (e.g., optionally with respect to a model, etc.).

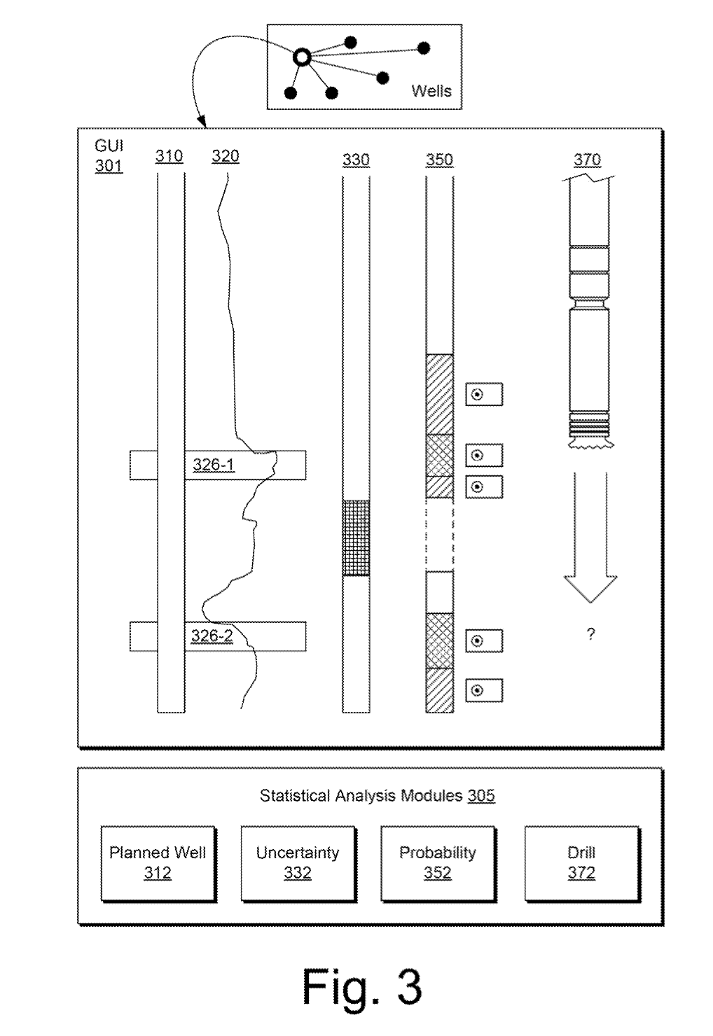

FIG. 3 shows an example of a GUI 301 that includes various types of information germane to a well (see, e.g., open circle), which may be a proposed new well or a new well being drilled. As indicated, the information may be based on data from one or more other, offset wells (see, e.g., filled circles). In the example of FIG. 3, the information in the GUI 301 may be derived, at least in part, through use of one or more statistical analysis modules 305. Such modules can include a planned well model 312, an uncertainty module 332, a probability module 352 and a drill module 372.

As an example, the GUI 301 includes a well graphic 310 illustrated with respect to depth, a log graphic 320 (e.g., optionally of probability of occurrence values for one or more types of events), one or more problem zone graphics 326-1 and 326-2, an uncertainty graphic 330, a probability of occurrence graphic 350 and a drill graphic 370. The modules 305 may include instructions for organizing and rendering that graphics 310, 320, 326-1, 326-2, 330, 350 and 370 (e.g., for execution by one or more processors, which may be CPUs, GPUs, CPUs and GPUs, etc.).

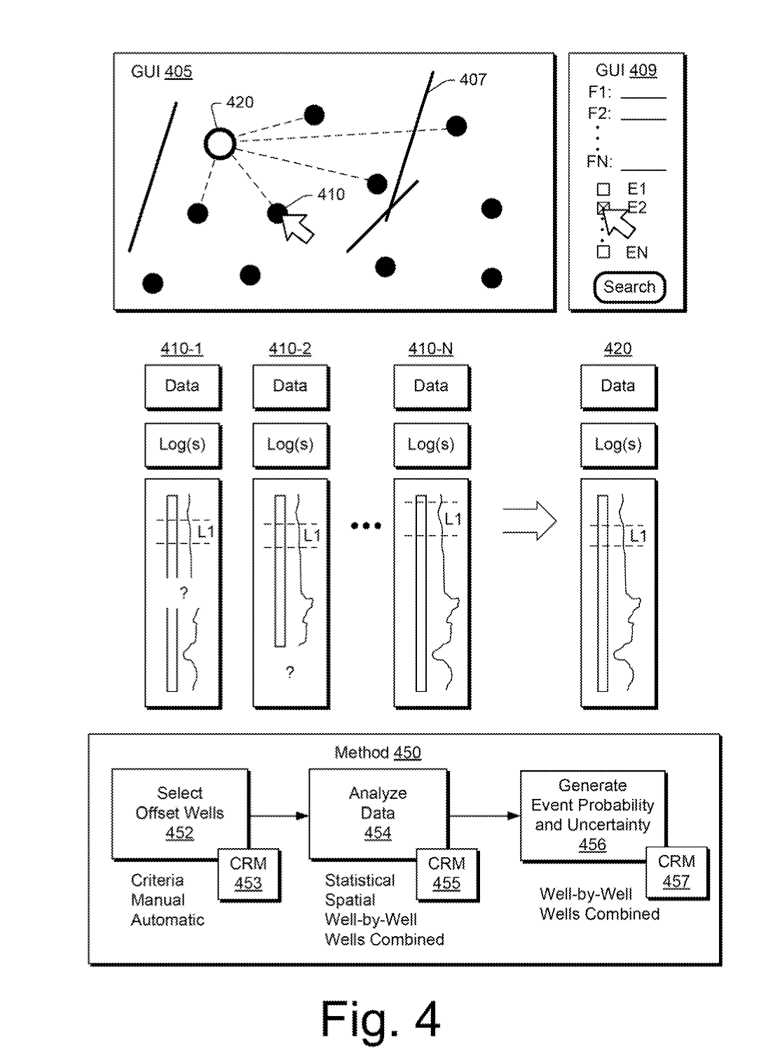

FIG. 4 shows an example of GUI 405 of a geologic environment, an example of a GUI 409 of filters, search options, etc., and an example of a method 450 where the GUI 405 of the geologic environment includes one or more features 407 and various wells that may be collectively or individually selected 410 for association with a proposed new well 420 (e.g., manually, automatically, via search, via filters, etc.). With respect to well selection, a database may include entries for wells with respect to types of events encountered. Such a database may include associations between data and types of events, for example, in the form of an event model. As an example, a layer of a particular lithology having a certain thickness may be prone to influx. A search engine for the database (e.g., accessible via the GUI 409) may allow for entry of an event (e.g., “E”), lithology (e.g., in a field “F”), or event and lithology to return well identifiers, optionally ranked in terms of relevance. As an example, one or more filters (e.g., F1, F2, . . . FN) may be applied to limit the search to wells that have been modeled. In turn, a graphical representation of the model may be rendered to a display that shows ranked wells (e.g., as a list, geographically on a map, optionally color coded as to rank or other criteria, etc.). As an example, some of the wells in the GUI 405 may be search results (e.g., based on information returned by a search engine). Given such a representation, a graphical user interface may allow a user to select particular wells for inclusion in an analysis for a proposed new well. Where a location for a proposed new well is provided, a radius about that well may optionally be entered for purposes of limiting search results, well selection, etc. As another example, a user may draw a boundary, optionally in 3D, to select wells or portions of wells (e.g., to associate data for those wells, portions of wells, etc., with an analysis for a new well).

As an example, a search engine may provide a degree of uncertainty for a well (e.g., and its data) with respect to one or more search criteria. For example, a relevance score produced by a search engine for a well may be assigned to the well as indicia of its uncertainty with respect to the search criteria (see, e.g., the GUI 409), which may be event-related (see, e.g., E1, E2, . . . EN). As another example, alternatively or additionally, a relevance score may be used as a weight for data from a selected well when calculating a probability of an event occurring for a proposed new well.

Further, as to searching, a retrieval model can estimate relevance of various well data sets (e.g., documents) responsive to a query and rank the well data sets (e.g., documents) accordingly. However, such an approach may ignore uncertainty associated with the estimates of relevancy. In such a situation, if a high estimate of relevancy also has a high uncertainty, then a highly ranked well data set may be quite relevant or not quite relevant; and another well data set may have a slightly lower estimate of relevancy but the corresponding uncertainty may be much less. As an example, a framework for modeling uncertainty can introduce an asymmetric loss function having a parameter that can model the level of risk (e.g., a level that one is willing to accept). In such an example, by adjusting the risk preference parameter, the framework can adapt to different retrieval strategies. Such a framework is described in an article by Zhu et al., “Risky Business: Modeling and Exploiting Uncertainty in Information Retrieval” (SIGIR '09, Jul. 19-23, 2009). As an example, graphics may be generated based on uncertainty for data associated with wells and presented with respect to a map (e.g., a 2D map or 3D map). In such an example, color coding, size coding, etc., may be applied to show wells or portions of wells where data uncertainty is high for any of a variety of reasons (e.g., amount of data, proximity to a location, search-related, event-related, lithology-related, time-related, etc.).

As shown in FIG. 4, data and log(s) for each of the selected wells 410-1, 410-2, . . . 410-N may be analyzed to provide information for the proposed new well 420. For the selected wells 410-1, 410-2 to 410-N, each is shown as including a layer L1, which may be defined based on data for one or more physical properties. As indicated, the layer L1 may be at different depths for each of the selected wells; thus, when interpolating the data for its relevance to the proposed new well 420, some uncertainty exists. Further, the data for the well 410-1 is missing data for a depth range and the data for the well 410-2 is not as deep as the proposed new well 420. These factors introduce uncertainty when calculating probability of occurrence of an event or events for the proposed new well.

As to the example method 450, it includes a selection, block 452, an analysis block 454 and a generation block 456. As indicated, the selection block 452 may provide for criteria-based selection, manual selection, automatic selection, etc.; the analysis block 454 may provide for statistical, spatial, well-by-well, combined well, etc., analyses; and the generation block 457 may generate event probability and uncertainty using a well-by-well approach, a wells combined approach, or other approach. In the well-by-well approach, generation may occur for each selected offset well, which, in turn, may be combined for a proposed new well; whereas, the wells combined approach may pool data from various selected offset wells for generation of event probability and uncertainty.

The method 450 is shown in FIG. 4 in association with various computer-readable media (CRM) blocks 453, 455, and 457. Such blocks generally include instructions suitable for execution by one or more processors (or cores) to instruct a computing device or system to perform one or more actions. While various blocks are shown, a single medium may be configured with instructions to allow for, at least in part, performance of various actions of the method 450. As an example, a computer-readable medium (CRM) may be a computer-readable storage medium. One or more CRM block may be provided for GUIs, etc. (see, e.g., GUIs 405 and 409 as well as graphics for selected wells 410-1, 410-2 to 410-N).

As an example, a method can include proposing a new well; accessing data associated with at least one other well where at least a portion of the data includes indicia of uncertainty; performing a geostatistical analysis (e.g., Bayesian or other) of the accessed data for an issue for drilling of the new well to provide a probability of occurrence for the issue and an uncertainty for the accessed data; and rendering to a display a graphical representation of the well, the probability of occurrence for the issue and the uncertainty for the accessed data as a function of depth. Such a method may further include, for example, drilling the proposed new well, acquiring data during the drilling of the proposed new well (e.g., stemming from drilling of the proposed well), performing a geostatistical analysis based at least in part on the data acquired during the drilling of the proposed well for an issue for drilling of the new well to provide a probability of occurrence for the issue and an uncertainty for the acquired data. As an example, a method can include issuing an alarm based on a probability of occurrence for an issue and uncertainty of the data underlying the probability.

As an example, proposing a new well can include modeling a geologic environment using a numerical technique that relies on a grid of the geologic environment. In such an example, the modeling of the geologic environment can include analyzing seismic data acquired from the geologic environment.

As an example, a method can include importing data from a geological environment modeling framework prior to the performing a geostatistical analysis where performance of the geostatistical analysis occurs using one or more drilling modules executed by a computer.

As an example, an issue may be a fluid influx issue, for example, where a method includes storing an instruction to call for an increase in mud weight during drilling of a proposed new well to mitigate the fluid influx issue and, during drilling of the proposed new well, based on the stored instruction, calling for the increase in mud weight (e.g., where a controller responds to the call and acts to increase the mud weight). As to other issues, issues such as fluid losses, drill-pipe or borehole washouts, sticking pipe, lost circulation, low ROP, abrasive sands, etc., may be specified. As an example, a method may include storing an instruction to call for a decrease in mud weight during drilling of a proposed new well to mitigate the fluid loss issue and, during drilling of the proposed new well, based on the stored instruction, calling for the decrease in mud weight (e.g., where a controller responds to the call and acts to decrease the mud weight).

As to a fluid, it may be liquid, gas, liquid and gas, etc. As an example, a fluid may include dissolved material (e.g., dissolved organics, inorganics, or organics and inorganics).

As to control, as an example, a method can include storing instructions for preventive control for an issue, based on a probability of occurrence for the issue and uncertainty of the data underlying the probability. Such preventive control may aim to mitigate an issue during drilling of a proposed new well.

As an example, a system can include one or more processors; memory; an interface to receive information for a proposed new well and to receive data associated with at least one other well where at least a portion of the data comprises indicia of uncertainty; instructions stored in a portion of the memory and executable by at least one of the one or more processors to perform a geostatistical analysis (e.g., a Bayesian or other analysis) of the received data for an issue for drilling of the new well to provide a probability of occurrence for the issue and an uncertainty for the received data; and instructions stored in a portion of the memory and executable by at least one of the one or more processors to render to a display a graphical representation of the well, the probability of occurrence for the issue and the uncertainty for the received data as a function of depth. Such a system may further include a base station and a mobile station where the mobile station may include a display for presentation of graphics.

As an example, a system can include instructions stored in a portion of memory and executable by at least one of one or more processors to render to a display a graphical user interface for entry of search terms, transmission of the search terms to a search engine and return of search results that list the at least one other well. As mentioned, the GUI 409 may provide for entry of search terms (e.g., field entries, events, etc.), transmission of search terms to a search engine (see, e.g., “Search” button control graphic) and provide for return of search results (see, e.g., the GUI 405, which may be a color coded map of search results as wells).

As an example, one or more computer-readable storage media can include computer-executable instructions to instruct a computing device to: access data associated with at least one well where at least a portion of the data comprises indicia of uncertainty; perform a geostatistical analysis of the accessed data for an issue for drilling of a new well to provide a probability of occurrence for the issue and an uncertainty for the accessed data; and store to memory information for rendering a graphical representation of the well, the probability of occurrence for the issue and the uncertainty for the accessed data as a function of depth. Such an example may also include instructions to instruct a computing device to: receive real time data acquired by drilling equipment during drilling of the new well; and perform a geostatistical analysis of the received data for an issue for drilling of the new well to provide a probability of occurrence for the issue and an uncertainty for the received data. As an example, one or more computer-readable storage media can include computer-executable instructions to instruct a computing device to store to memory information for preventive control during drilling of a new well where the preventive control is based at least in part on the probability of occurrence for the issue and the uncertainty of the received data.

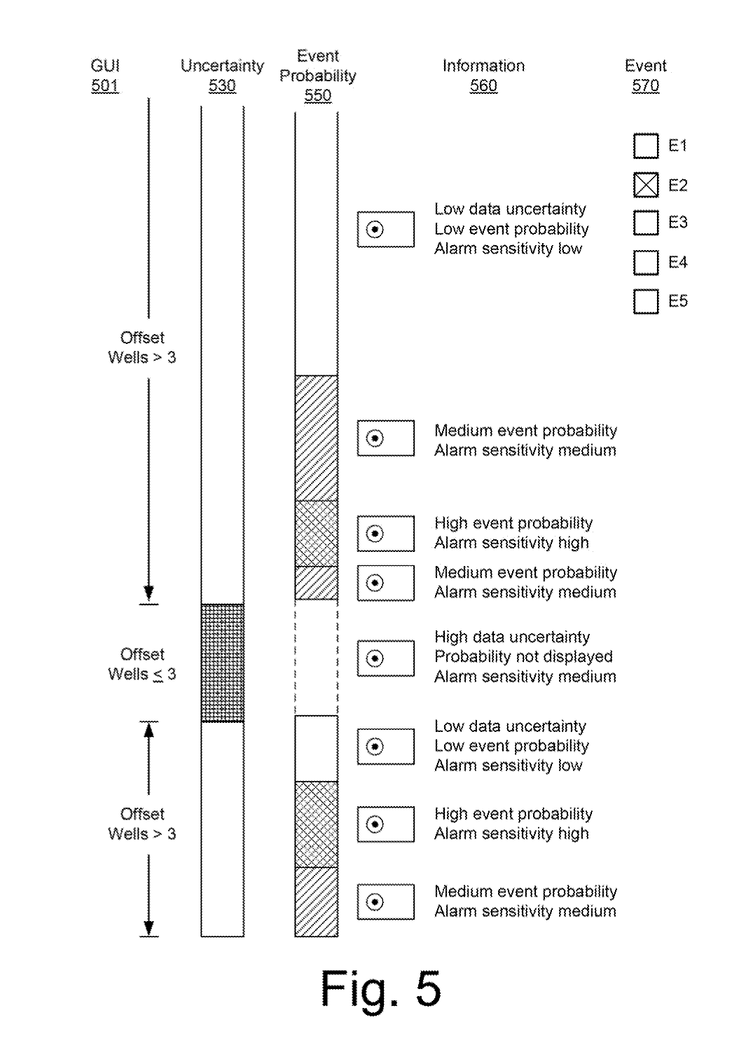

FIG. 5 shows an example of a graphical user interface (GUI) 501 with respect to depth for an uncertainty graphic 530, an event probability graphic 550, and various information graphics 560 along with an event type selection graphical control 570. In the example of FIG. 5, the hatching and cross-hatching may represent colors or other visualizations. For example, where no hatching or cross-hatching appear in the event probability graphic 550 the corresponding event probability may be low; whereas, hatching indicated medium event probability and cross-hatching indicates high event probability. For the uncertainty graphic 530, a screen pattern indicates high data uncertainty (e.g., unacceptable degree of uncertainty in data) for a depth range. As an example of an unacceptable limit for uncertainty, in the example of FIG. 5, the underlying data for the screen portion of the uncertainty graphic 530 may be for fewer that a particular number of offset wells (e.g., fewer than about 3). In response to the data falling within the unacceptable limit, the event probability graphic 550 does not show event probability for that depth range.

As an example, a limit as to acceptability or unacceptability of uncertainty may optionally be depth dependent. For example, events may be handled more readily at shallower depths and therefore a higher degree of uncertainty may be acceptable than for deeper depths where more time, equipment, cost, etc., are involved and where remedies may be more limited. Thus, an uncertainty scale may be depth dependent and, accordingly, a particular uncertainty may impact display of event probability information, control, sensing, alarms, etc., differently with respect to depth.

In the example of FIG. 5, the information 560 can include various types of quantitative, qualitative or quantitative and qualitative information. Further, interactive graphic controls may be displayed where a user can interrogate the underlying data, selected wells, analysis, etc., and optionally other information (e.g., controls, sensing, alarms, etc.). In the example of FIG. 5, the information 560 also includes some alarm sensitivity information. Such sensitivity may involve adjusting one or more alarm limits, data acquisition frequencies, sensor parameters, etc.

As to the event type selection graphic control 570, this may allow a user to select one or more types of events. For example, the events may include kicks, fluid losses, drill-pipe or borehole washouts, sticking pipe, lost circulation, low ROP, abrasive sands, or other types of events.

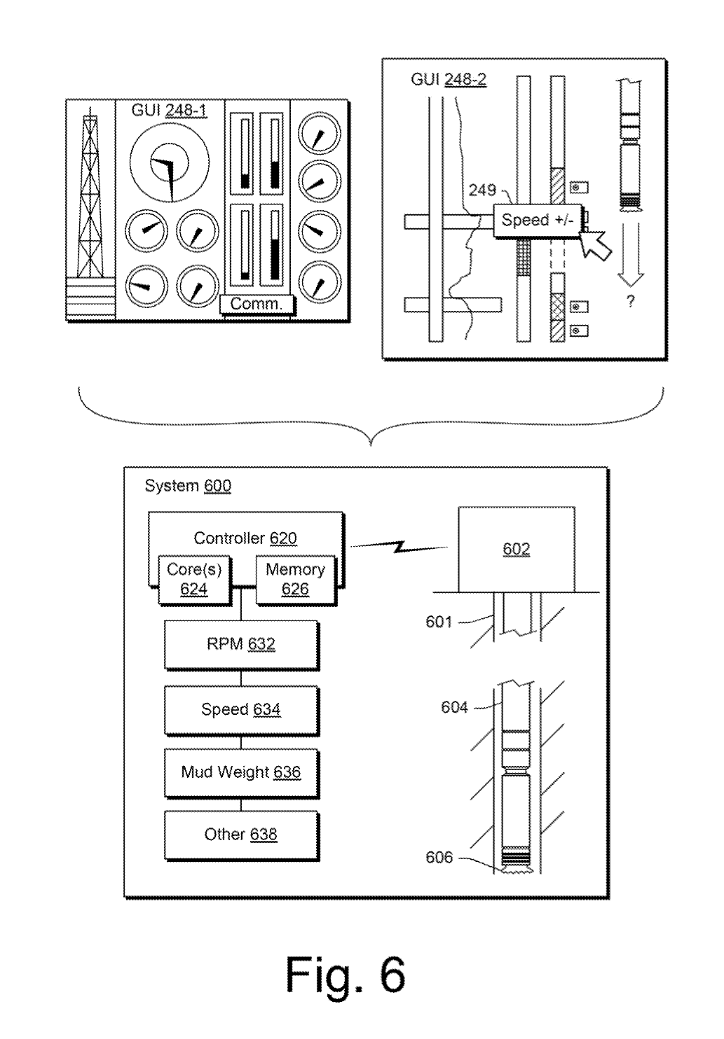

FIG. 6 shows an example of a system 600 that may respond to input received via one or more graphical user interfaces (GUIs) such as the GUIs 248-1 and 248-2. In the example of FIG. 6, the system 600 includes drilling equipment 602, 605 and 606 positioned with respect to a well 601 being drilled. A controller 620 includes one or more cores (e.g., processing cores or processors) 624 and memory 626. The controller 620 may be local or remote with respect to the well 601 and include one or more interfaces for communication with at least some of the drilling equipment 602. As an example, the controller 620 may include one or more modules for controlling rotational speed 632, directional speed 634, mud weight 636 or other aspects of a drilling process 638.

Referring to the GUI 248-2, a drilling operator may interact with the GUI 248-2, for example, responsive to display of event probability, uncertainty, or both event probability and uncertainty for a particular event. As shown in the example of FIG. 6, a user may cause a control graphic 249 to appear via clicking on a portion of the GUI 248-2. Such a graphic may allow for transmission of an instruction to the controller 620 of the system 600 to alter one or more drilling operation parameters (e.g., rpm, speed, mud weight, etc.). Where data are collected in real time for the drilling operation, such data may feedback into an analysis that updates information displayed by one or more GUIs. For example, the drill graphic in the GUI 248-2 may proceed downward in depth and cause similar downward movement in event probability and uncertain information. The GUI 248-1 may be a real time monitoring and optionally control GUI for a drilling process. As an example, the GUI 248-1 may be a GUI provided by a framework such as the TECHLOG® framework. As an example, the GUI 248-2 may be integrated into such a framework (e.g., via code modification, add-on, plug-in, API, etc.).

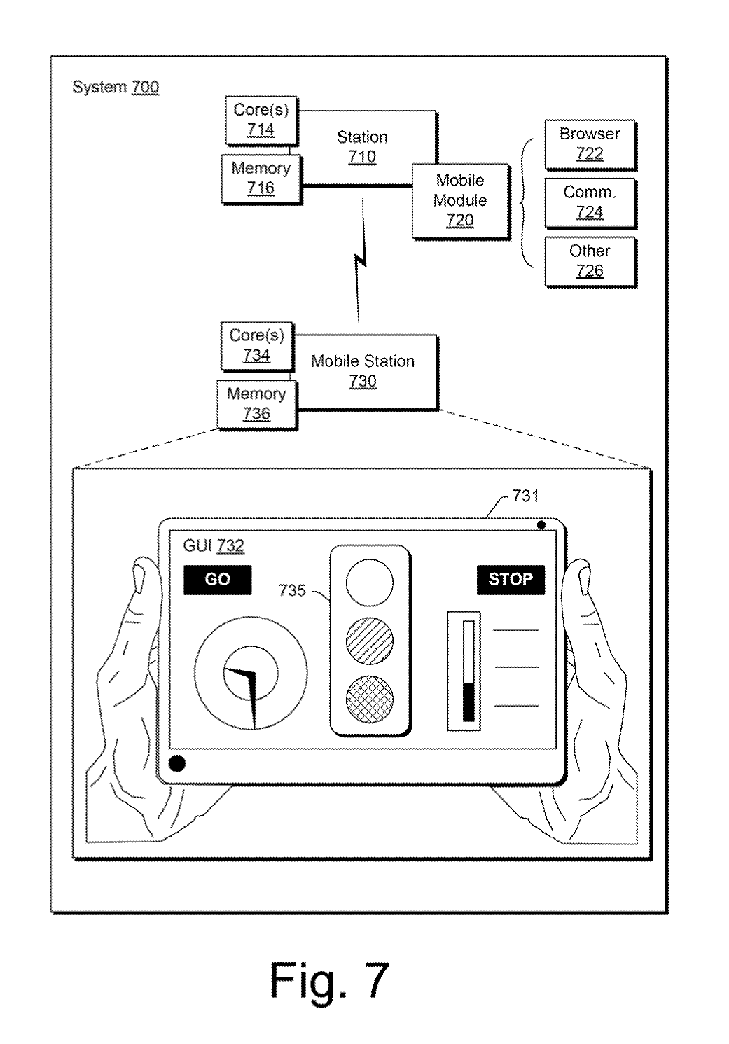

FIG. 7 shows an example of a system 700 that includes a station 710 and a mobile station 730. In the example of FIG. 7, the station 710 includes one or more cores 714 and memory 716 as well as a mobile module 720, which may include browser instructions 722, communication protocol instructions 724 and other instructions 726. In the example of FIG. 7, the mobile station 730 may include a device such as a tablet device 731 that includes one or more cores 734 and memory 736 configured with instructions (e.g., stored in the memory 736 and executable by at least one of the one or more cores 734) to render one or more GUIs 732 with various graphics that can assist with issue avoidance during drilling of a well. As an example, a graphic 735 appears as traffic light where one of the three lights may be illuminated (e.g., displayed with an intensity greater than the other two lights) to provide a drilling operator with an indication of probability of occurrence of an event. Various other types of information may also be rendered, for example, a measure of uncertainty, optionally on a linear or other scale. In the example of FIG. 7, the tablet device 732 includes stop and go graphics that may readily be actuated via touch by a drilling operator, for example, responsive to the color of the traffic light 735.

In the example of FIG. 7, the traffic light display may show a relative problem likelihood relative to a current drilling depth. In such an example, data uncertainty may determine whether (or how) the information is displayed. For example, a combined problem probability of occurrence and data uncertainty can determine sensitivity of one or more automated alarms. Although the traffic light (or traffic signal) approach includes three levels of granularity (e.g., for easy display assimilation), a complete range of data may be available in a monitoring system (e.g., the station 710) to drive alarm sensitivities and provide control signals for automation purposes with much finer granularity. Prediction ahead of a current drill bit position can provide for advanced warning of potential problems and can allow mitigation strategies to be prepared by a drilling team before one or more events are encountered. In such a manner, operational risks and the probability of occurrence of one or more types of events, which may result in safety or operational problems, may be reduced.

As an example, the station 710 may be a remote operations support center and that provides for communication of information for displays, alarms, etc. at a rig site. For example, the mobile station 730 may be equipment associated with a rig. In such an arrangement, the station 710 may include modeling capabilities (e.g., via PETREL® framework, etc.) where one or more domain experts perform tasks (e.g., workflow or other tasks) that control communication of relevant information for display at the rig equipment (e.g., or mobile phones, tablets, etc., at a drilling site) for consumption by personnel performing drilling or other activities related to drilling a new well (e.g., using the rig equipment).

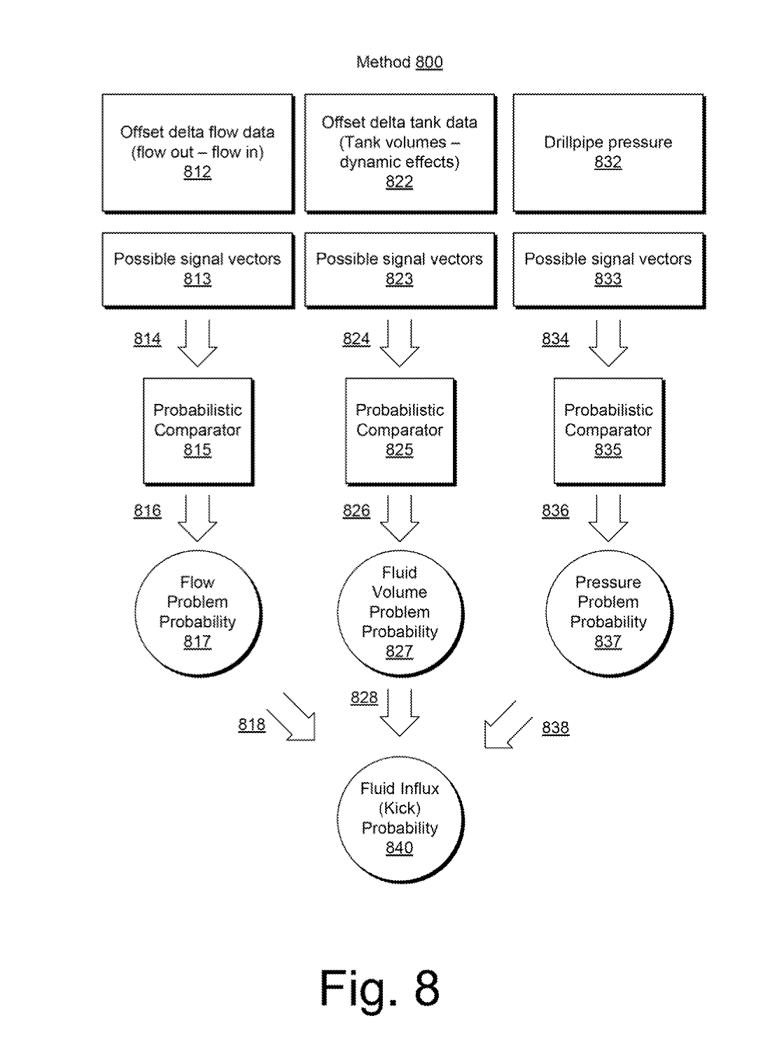

FIG. 8 shows an example of a method 800 with respect to a fluid influx event. In the example of FIG. 8, the method 800 include inputting 814, 824 and 834 various types of data 812, 822, 832 into to probabilistic comparators 815, 825, and 835 along with possible signal vectors 813, 823, and 833. As mentioned, a probabilistic comparator may compare a data vector with one or more possible signal vectors. In the example of FIG. 8, the method 800 includes outputting 816, 826 and 836 probabilities of occurrence (e.g., or non-occurrence) for flow 817, fluid volume event 827 and pressure 837. In turn, the method 800 includes receiving these probabilities 818, 828 and 838 for determining a combined probability of occurrence of a fluid influx event 840.

The method 800 may, for example, provide for automated data processing from offset wells for an event such as fluid influx (kick) detection. In such an example, recorded and stored signals from the offset data can be compared to a number of possible signals for computation of probability of occurrence of a particular problem as a function of depth (position) in the offset well. These problems may then be combined (e.g., for multiple measurements) to generate a probability log for occurrence of the type of event being analyzed. As an example, the log may be stored and analyzed in the context of an earth model to identify events that correlate with subsurface properties. As an example, these properties may be already derived from seismic or other previously recorded measurements, and enable identification of subsurface structures and lithology information. Such a method may be repeated for all offset wells in an area that has been drilled in similar lithology sequences to provide a reference model for a new proposed well.

As an example, the method 800 may automatically capture uncertainty, or bounds, for probability of occurrence logs. For example, if relatively few offset wells are used for a log, or a log is derived from a poor measurement(s), then such information can be stored with the log (e.g., as an uncertainty indicator).

As an example, in addition to event probabilities, other valuable information can be gained from one or more offset wells. Examples can include estimates of pore and fracture pressure, models of rock hardness, susceptibility to swelling and estimates of parameters of models such as the bit-rock interaction. What makes these logs different to event probability logs is that they are estimates of physical properties and can thereby provide probabilities of problematic events, for example, when combined with real time parameters such as drilling fluid properties, bit type, etc. By separating the probability of occurrence of an event from drilling parameters used in an offset well, as an example, a method can create a new probability log for use drilling a new well (e.g., using new drilling parameters). Such a method can assist during planning phases of a new well.

As an example, the method 800 may provide for outputting a lost circulation probability. As mentioned, excessive mud weight can cause lost circulation by propagating, and then filling, fractures in rock. Various data may be provided related to lost circulation factors along with possible signal vectors for the data to allow one or more probabilistic comparators (see, e.g., 815, 825 and 835) to output one or more probabilities that may provide an overall probability for a lost circulation issue. In the foregoing example for lost circulation, as in the example for fluid influx (“kick”), uncertainty or uncertainties may be provided at the data level (e.g., block 812, 822 and 832), at the possible signal vector level (e.g., blocks 813, 823 and 833), at the comparator level (e.g., blocks 815, 825 and 835) or at one or more other levels. As mentioned, as to an event (e.g., lost circulation, fluid influx, etc.), one or more graphics may be presented in terms of probability with respect to depth for a proposed new well or a new well being drilled along with indicia of uncertainty as to the probability. As mentioned, where uncertainty is deemed high for probability (e.g., according to one or more criteria), a graphical presentation may forego display of that probability (e.g., with respect to depth). Thus, a graphic generation or rendering process may include a decision block that decides whether a graphic for a probability should be generated or whether a graphic for a probability should be rendered (e.g., to a display).

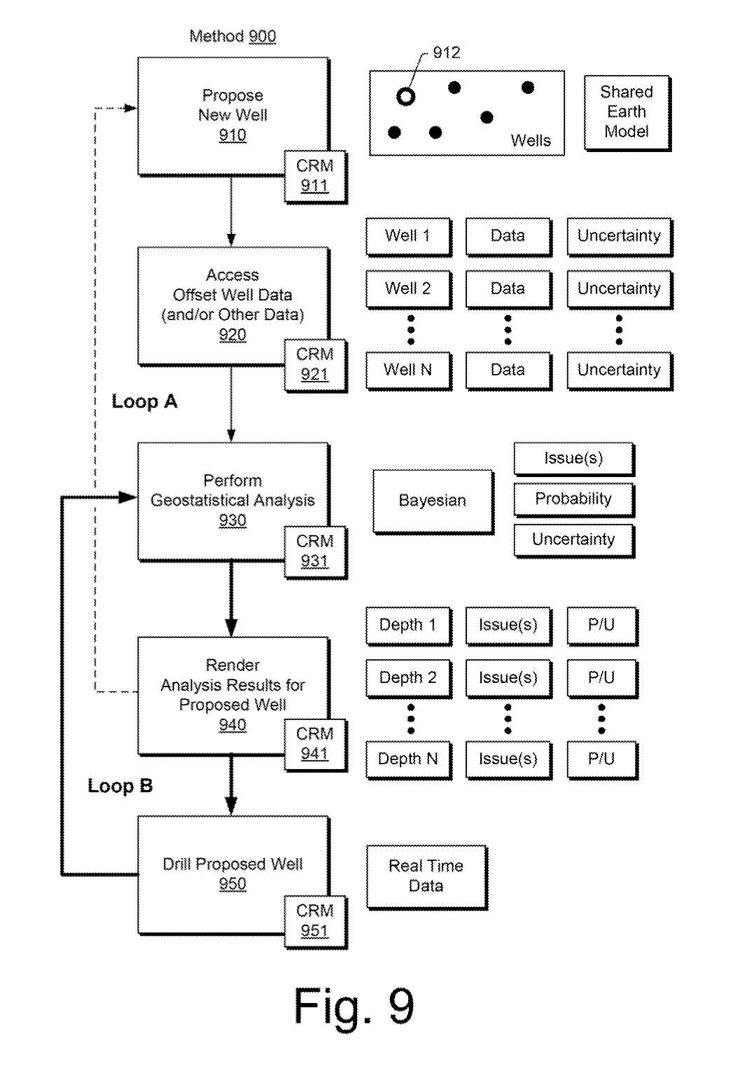

FIG. 9 shows an example of a method 900. In the method 900, a proposal block 910 includes proposing a new well (see, e.g., well 912); an access block 920 includes accessing offset well data and optionally other data; a performance block 930 includes performing one or more geostatistical analyses; a render block 940 include rendering analysis results for the proposed new well to a display (e.g., storing information to memory for rendering to a display); and a drill block 950 includes drilling the proposed new well.

In the example of FIG. 9, two loops are shown: Loop A and Loop B. Loop A may be a feedback loop for updating one or more aspects of a proposed well based on analysis results and Loop B may be a feedback loop for performing one or more additional geostatistical analyses based on information acquired while drilling a proposed new well (e.g., information sensed or acquired by drilling equipment drilling the wellbore for the new well).

The method 900 is shown in FIG. 9 in association with various computer-readable media (CRM) blocks 911, 921, 931, 941, and 951. Such blocks generally include instructions suitable for execution by one or more processors (or cores) to instruct a computing device or system to perform one or more actions. While various blocks are shown, a single medium may be configured with instructions to allow for, at least in part, performance of various actions of the method 900. As an example, a computer-readable medium (CRM) may be a computer-readable storage medium.

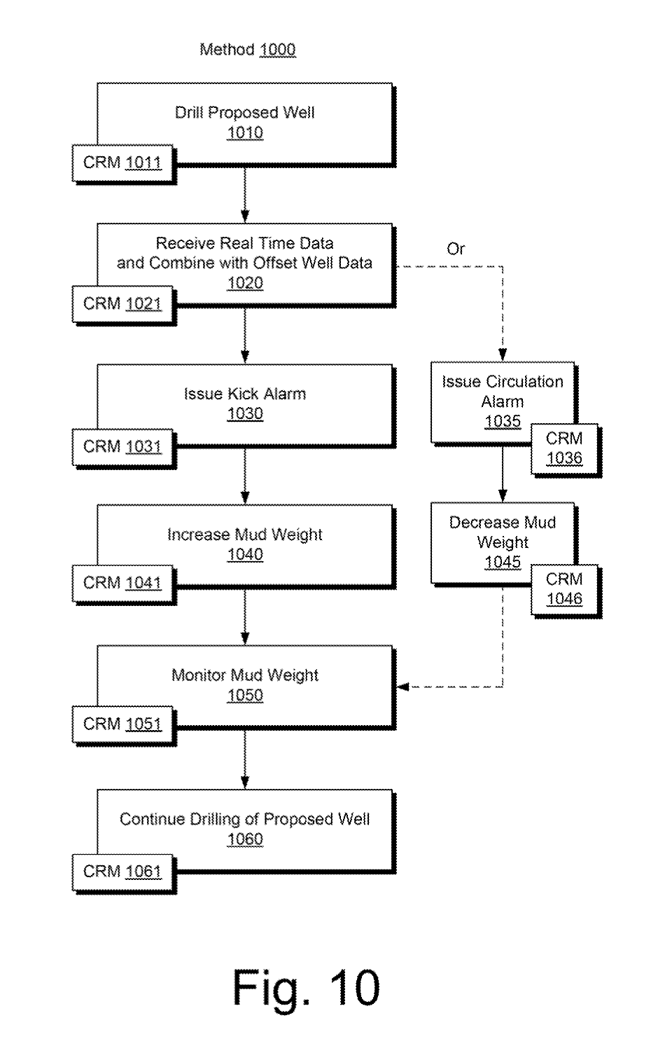

FIG. 10 shows an example of a method 1000 that includes a drill block 1010 for drilling a proposed well; a reception block 1020 for receiving real time data and combining the real time data with offset well data; an issue block 1030 for issuing a kick alarm; an increase block 1040 for increasing mud weight responsive to the kick alarm; a monitor block 1050 for monitoring mud weight and a continuation block 1060 for continuing drilling of the proposed well. In the example of FIG. 10, the issue block 1030 may include issuing an instruction to a mud controller to increase mud weight. While the issue block 1030 shows issuance of an alarm, the alarm may be a preventive alarm for purposes of avoiding an actual kick. For example, an analysis of the received data may indicate a high probability of occurrence of a kick event at a particular depth being approached by a drill bit. Where the high probability of occurrence is accompanied by a low uncertainty as to data underlying the probability calculation, the method 1000 may issue the kick alarm with or without operator intervention. For example, given assurances as to data underlying a high probability of occurrence of a kick event, the method 1000 may automatically act to increase mud weight to avoid the probable kick event. Where uncertainty is higher, as an example, a method may include issuing an alarm (e.g., audible, mechanical, visual, etc.) to an operator indicating that a mud weight increase instruction is going to be sent. Actual issuance of such an instruction may be subject to receipt of input from the operator or possibly subject to override by input of a command by the operator (e.g., within a certain period of time).

As shown in the example of FIG. 10, the method 1000 may additionally or alternatively apply to an event such as lost circulation (e.g., fluid loss issue), for example, where excessive mud weight can cause lost circulation by propagating, and then filling, fractures in rock. For example, a method may include a loop for lost circulation that acts to decrease mud weight responsive to issuance of a lost circulation alarm (e.g., in an effort to avoid lost circulation). As shown, the method 1000 can proceed to an issue block 1035 for issuing a circulation alarm and then proceed to a decrease block 1045 for decreasing mud weight (e.g., the issue block 1035 may include issuing an instruction to a mud controller to decrease mud weight). Accordingly, the method 1000 may be adapted to respond by increasing or decreasing mud weight depending on the type of alarm issued.

The method 1000 is shown in FIG. 10 in association with various computer-readable media (CRM) blocks 1011, 1021, 1031, 1036, 1041, 1046, 1051, and 1061. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1000. As an example, a computer-readable medium (CRM) may be a computer-readable storage medium.

As another example, a method may pertain to a drillstring sticking issue. In such an example, an issue block may issue an alarm for a drillstring sticking issue for a drillstring being used or to be used for drilling a well. Such an alarm may be issued based on an analysis of geological data associated with at least one other well. For example, if an analysis of geological data for another well indicates that a layer (see, e.g., layer “L1” in FIG. 4) may pose a high probability of occurrence of a drillstring sticking event (e.g., with an acceptable level of certainty/uncertainty), then an alarm may be issued (e.g., during a simulation or actual drilling) or optionally an instruction may be stored for later recall and issuance during actual drilling (e.g., in an effort to avoid sticking of the drillstring). As an example, during drilling of a well, where a sticking event occurs, quantitative, qualitative or qualitative and quantitative data may be stored and accessed for purposes of planning of a new well, drilling of a new well, or planning and drilling of a new well (e.g., to avoid a sticking event).

As an example, so-called differential sticking may occur such that a drillstring cannot readily be moved (e.g., rotated or reciprocated) along an axis of a wellbore. Differential sticking can occur when high-contact forces caused by low reservoir pressures, high wellbore pressures, or both, are exerted over a sufficiently large area of a drillstring. Differential sticking can result in delays and financial costs. Sticking force may be determined as a product of a differential pressure between a wellbore and a reservoir and an area that the differential pressure is acting upon (e.g., a relatively low differential pressure applied over a large working area can be just as effective in sticking pipe as can a high differential pressure applied over a small area). As another example, so-called mechanical sticking involves limiting or prevention of motion of a drillstring by anything other than differential pressure sticking. Mechanical sticking can be caused by debris in a hole, wellbore geometry anomalies, cement, keyseats or a buildup of cuttings in the annulus. As an example, mechanical sticking may be caused by packing-off (e.g., cuttings settling back into a wellbore, especially when circulation is diminished or stopped). As another example, mechanical sticking may be caused by adhesion (e.g., after a lack of movement for some amount of time).

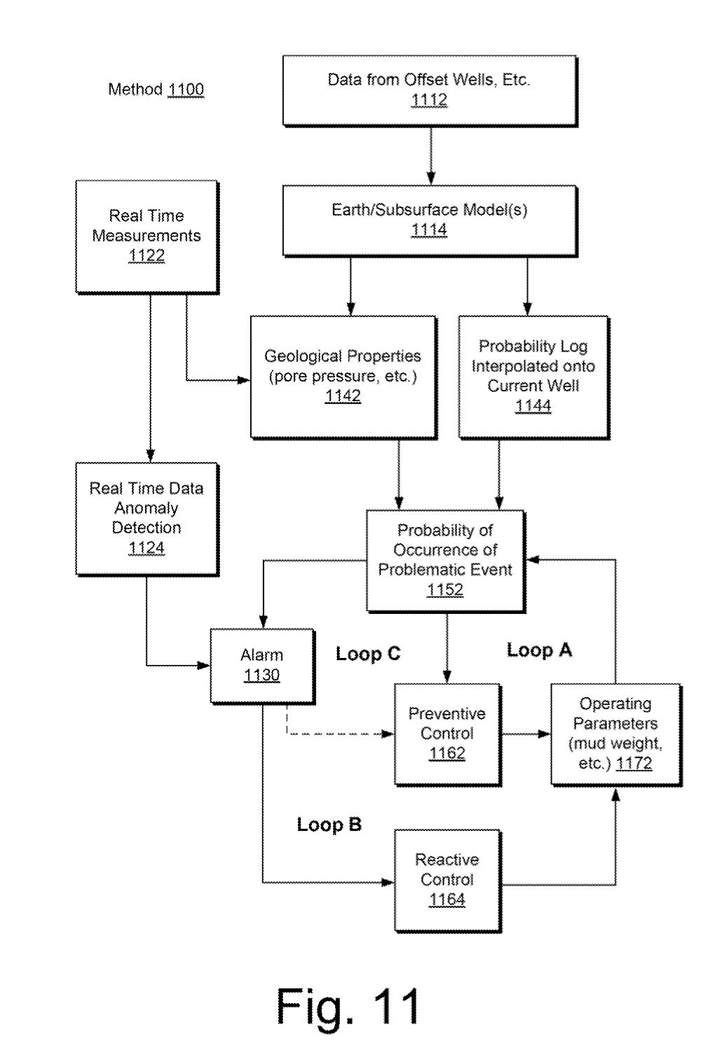

FIG. 11 shows an example of a method 1100 that includes a data block 1112 for providing data from at least one or more offset wells; a model block 1114 for modeling a geologic environment; a real time measurement block 1122 for making real time measurements; a real time data anomaly detection block 1124 for detecting one or more anomalies in real time data (e.g., indicative of a problem, issue, event, etc.); an alarm block 1130 for issuing alarms; a geological properties block 1142 for determining one or more geological properties (e.g., based on measurements, modeling, data, etc.); a probability log block 1144 for calculating probability logs and interpolating information with respect to a current or proposed well; a probability of occurrence of a problematic event block 1152 for calculating one or more probabilities of occurrence of a problematic event (e.g., with respect to depth or multidimensional path for a well); a preventive control block 1162 for effectuating preventive control to avoid an event; a reactive control block 1164 for effectuating reactive control responsive to occurrence of an event and an operating parameters block 1172 for providing or adjusting one or more operating parameters with respect to a drilling operation.

In the example of FIG. 11, Loops A, B and C are shown. The Loop A corresponds to a preventive control feedback loop where the preventive control block 1162 effectuates preventive control by adjusting one or more parameters of the operating parameters block 1172, which, in turn, acts to provide an indication of such adjusting to the probability of occurrence block 1152.

As to Loop B, it corresponds to a reactive control feedback loop where the reactive control block 1164 effectuates reactive control by adjusting one or more parameters of the operating parameters block 1172, which, in turn, acts to provide an indication of such adjusting to the probability of occurrence block 1152, which, in turn, acts to adjust the alarm block 1130, which may also receive input from the real time data anomaly detection block 1124. In such a manner, the alarm block 1130 may issue an alarm based on probability of occurrence of an event, based on detection of an anomaly in real time data or a combination of both.

As to Loop C, such a loop may be optional depending on the configuration of the alarm block 1130 with respect to the preventive control block 1162. Loop C operates in a manner similar to Loop A but with inclusion of the alarm block 1130; which may receive information via the real time data anomaly detection block 1124.

As an example, when a probability model for a particular type of event has been produced for a new proposed well, this forms a reference model that can be used to anticipate drilling problems during the well planning stage. When the well is actually drilled, the reference model may be used to provide advanced warnings before one or more problem zones are reached. A reference model may optionally be implemented in a manner to adjust sensitivity of one or more semi-automated or automated detection systems to give greater sensitivity to a problem being detected in a zone(s) that has been previously estimated to have a high probability of occurrence of a particular problem. As an example, detector sensitivity may be reduced where is there is a small probability of occurrence of a problem zone to reduce a false alarm rate of the detector. Such an approach may be implemented by adjusting a “prior probability” of the model being tested against the data. As an example, one or more logs may be used to drive a semi-automated or an automated system, for example, where uncertainty of the logs (e.g., as to underlying data) is incorporated into a decision making process (e.g., using one or more utility functions where the “cost” of the problematic event occurring is weighted by the probability of occurrence).

As an example, a method or a system may provide for efficient end-to-end well planning using offset well information to allow improved early detection and avoidance of problems in a new well to be drilled or actually being drilled.

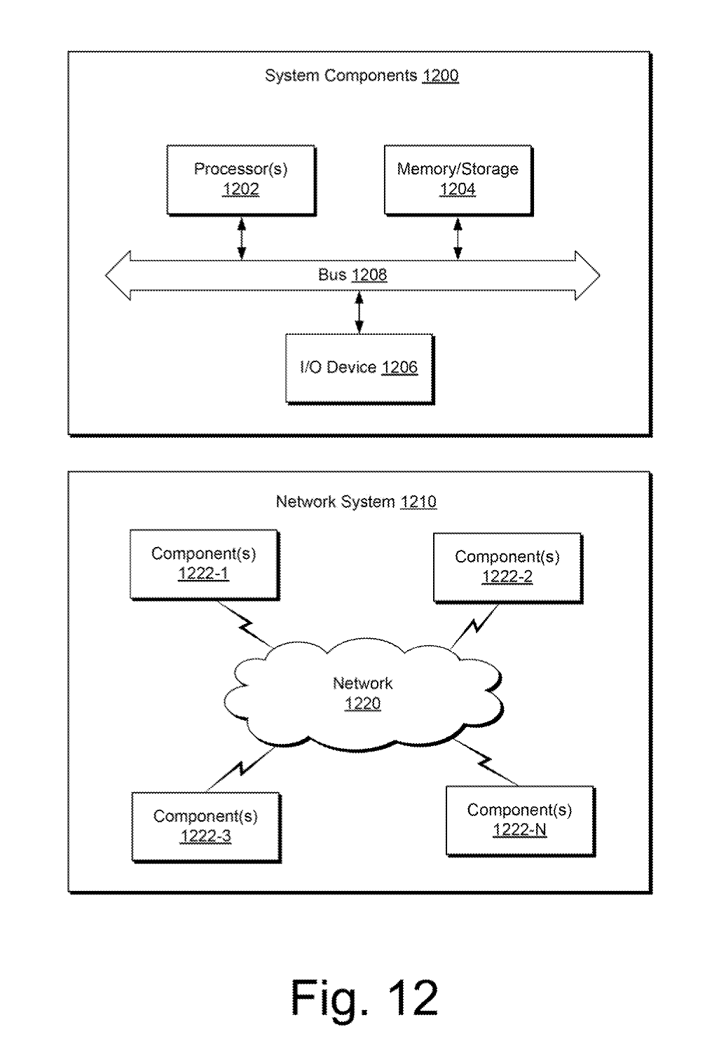

FIG. 12 shows components of an example of a computing system 1200 and an example of a networked system 1210. The system 1200 includes one or more processors 1202, memory and/or storage components 1204, one or more input and/or output devices 1206 and a bus 1208. In an example embodiment, instructions may be stored in one or more computer-readable media (e.g., memory/storage components 1204). Such instructions may be read by one or more processors (e.g., the processor(s) 1202) via a communication bus (e.g., the bus 1208), which may be wired or wireless. The one or more processors may execute such instructions to implement (wholly or in part) one or more attributes (e.g., as part of a method). A user may view output from and interact with a process via an I/O device (e.g., the device 1206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1210. The network system 1210 includes components 1222-1, 1222-2, 1222-3, . . . 1222-N. For example, the components 1222-1 may include the processor(s) 1202 while the component(s) 1222-3 may include memory accessible by the processor(s) 1202. Further, the component(s) 1222-2 may include an I/O device for display and optionally interaction with a method. The network may be or include the Internet, an intranet, a cellular network, a satellite network, etc.

Although a few example embodiments have been described in detail above, those skilled in the art will readily appreciate that many modifications are possible in the example embodiments without materially departing from the embodiments of the present disclosure. Accordingly, such modifications are intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

1. A method comprising:
proposing a new well;
accessing data associated with at least one other well wherein at least a portion of the data comprises indicia of uncertainty;
performing a geostatistical analysis of the accessed data for an issue for drilling of the new well to provide a probability of occurrence for the issue and an uncertainty for the accessed data; and
rendering to a display a graphical representation of the well, the probability of occurrence for the issue and the uncertainty for the accessed data as a function of depth.

2. The method of claim 1 further comprising drilling the proposed new well.

3. The method of claim 2 further comprising acquiring data during the drilling of the proposed new well.

4. The method of claim 3 further comprising performing a geostatistical analysis based at least in part on the data acquired during the drilling of the proposed new well for an issue for drilling of the new well to provide a probability of occurrence for the issue and an uncertainty for the acquired data.

5. The method of claim 1 wherein the geostatistical analysis comprises a Bayesian analysis.

6. The method of claim 1 wherein the proposing a new well comprises modeling a geologic environment using a numerical technique that relies on a grid of the geologic environment.

7. The method of claim 6 wherein the modeling a geologic environment comprises analyzing seismic data acquired from the geologic environment.

8. The method of claim 1 further comprising importing data from a geological environment modeling framework prior to performing a geostatistical analysis wherein performing a geostatistical analysis occurs using one or more drilling modules executed by a computer.

9. The method of claim 1 wherein the issue comprises a fluid influx issue or a fluid loss issue.

10. The method of claim 9 further comprising storing an instruction to call for an increase in mud weight during drilling of the proposed new well to mitigate the fluid influx issue or storing an instruction to call for a decrease in mud weight during drilling of the proposed new well to mitigate the fluid loss issue.

11. The method of claim 1 wherein the issue comprises a sticking issue for a drillstring.

12. The method of claim 1 further comprising storing instructions for preventive control, based on the probability of occurrence for the issue and the uncertainty of the data, for mitigating the issue during drilling of the proposed new well.

13. The method of claim 4 further comprising issuing an alarm based on the probability of occurrence for the issue and the uncertainty of the data.

14. A system comprising:
one or more processors;
memory;
an interface to receive information for a proposed new well and to receive data associated with at least one other well wherein at least a portion of the data comprises indicia of uncertainty;
instructions stored in a portion of the memory and executable by at least one of the one or more processors to perform a geostatistical analysis of the received data for an issue for drilling of the new well to provide a probability of occurrence for the issue and an uncertainty for the received data; and
instructions stored in a portion of the memory and executable by at least one of the one or more processors to render to a display a graphical representation of the well, the probability of occurrence for the issue and the uncertainty for the received data as a function of depth.

15. The system of claim 14 further comprising instructions stored in a portion of the memory and executable by at least one of the one or more processors to render to a display a graphical user interface for entry of search terms, transmission of the search terms to a search engine and return of search results that list the at least one other well.

16. The system of claim 14 wherein the instructions to perform a geostatistical analysis comprise instructions to perform a Bayesian analysis.

17. The system of claim 14 further comprising a base station and a mobile station wherein the mobile station comprises the display.

18. One or more computer-readable storage media comprising computer-executable instructions to instruct a computing device to:
access data associated with at least one well wherein at least a portion of the data comprises indicia of uncertainty;
perform a geostatistical analysis of the accessed-data for an issue for drilling of a new well to provide a probability of occurrence for the issue and an uncertainty for the accessed data; and
store to memory information for rendering a graphical representation of the well, the probability of occurrence for the issue and the uncertainty for the accessed data as a function of depth.

19. The one or more computer-readable storage media of claim 18 further comprising computer-executable instructions to instruct a computing device to:
receive real time data acquired by drilling equipment during drilling of the new well; and
perform a geostatistical analysis of the received data for an issue for drilling of the new well to provide a probability of occurrence for the issue and an uncertainty for the received data.

20. The one or more computer-readable storage media of claim 18 further comprising computer-executable instructions to instruct a computing device to:
store to memory information for preventive control during drilling of the new well, the preventive control based at least in part on the probability of occurrence for the issue and the uncertainty of the received data.
